(19) United States
(12) Patent Application Publication
(10) Pub. No.: US 2008/0054789 A1
(43) Pub. Date: Mar. 6, 2008

(54) Plasma display panel (PDP)

(76) Inventors: Yoshitaka Terao, Yokohama-shi (JP); Yukika Yamada, Yokohama-shi (JP); Takashi Miyama, Yokohama-shi (JP)

Correspondence Address: Robert E. Bushnell, Suite 300, 1522 K Street, N.W., Washington, DC, 20005, US

(21) Appl. No.: 11/790,055

(22) Filed: Apr. 23, 2007

(30) Foreign Application Priority Data
Aug. 29, 2006 (JP) 2006-231720

(51) Int. Cl. H01J 1/62

(52) U.S. Cl. 313/485

(57) ABSTRACT

A Plasma Display Panel (PDP) having an increased coating area of a phosphor material and improved brightness and efficiency includes: a front substrate through which light is transmitted and a rear substrate facing the front substrate and in which a plurality of discharge spaces are arranged between the front substrate and the rear substrate; a first electrode arranged on the front substrate; a second electrode arranged on the rear substrate to cross the first electrode and to generate a discharge within one of the discharge spaces between the first electrode and the second electrode; a dielectric layer arranged on the rear substrate facing the discharge spaces and having a plurality of concavo-convex portions in a region defined by the discharge spaces; and a phosphor layer arranged on the concavo-convex portions.

### CLAIM OF PRIORITY

This application makes reference to, incorporates the same herein, and claims all benefits accruing under 35 U.S.C. §119 from an application for PLASMA DISPLAY PANEL earlier filed in the Japanese Patent Office on the 29 Aug. 2006 and there duly assigned Serial No. 2006-231720.

### BACKGROUND OF THE INVENTION

1. Field of the Invention

The present invention relates to a Plasma Display Panel (PDP). More particularly, the present invention is related to a PDP having an increased coating area of a phosphor material and improved brightness and efficiency.

2. Description of the Related Art

Recently, flat display devices employing a Plasma Display Panel (PDP) having a large screen with high definition and that can be formed to be thin and light in weight have been produced. Furthermore, the flat display devices have an excellent wide viewing angle. In addition, due to a simple manufacturing process in comparison with other flat display devices, a large-sized flat display device can be achieved. Therefore, the flat display devices are highly expected to become the next generation of large-sized display panels.

In order to improve emission efficiency of the PDP, the heights of barrier ribs defining discharge spaces have been increased. Furthermore, the barrier ribs have been manufactured to have a fine pitch. However, there has been a problem in that a complex manufacturing process is unavoidable when forming a pattern of the barrier ribs.

Therefore, a technique has been discovered for manufacturing barrier ribs of the PDP so as to obtain a low permittivity and high brightness by intentionally forming an air gap within the barrier ribs (for example, see Japanese Laid-Open Patent Application No. 2005-276762).

Since the barrier ribs of the PDP of Japanese Laid-Open Patent Application No. 2005-276762 are formed by patterning the barrier ribs, a maximum area for forming a phosphor. layer is constrained by inner walls of the barrier ribs disposed on a rear substrate. Accordingly, there is a limit to a maximum coating area of a phosphor material.

### SUMMARY OF THE INVENTION

The present invention provides a novel and improved Plasma Display Panel (PDP) having an increased coating area of a phosphor material and improved brightness and efficiency.

According to an aspect of the present invention, a plasma display panel is provided including: a front substrate to transmit light therethrough; a rear substrate facing the front substrate; a plurality of discharge spaces arranged between the front substrate and the rear substrate; a first electrode arranged on the front substrate; a second electrode arranged on the rear substrate to cross the first electrode to generate a discharge within one of the plurality of discharge spaces between the first electrode and the second electrode; a dielectric layer arranged on the rear substrate facing the plurality of discharge spaces and having a plurality of concavo-convex portions in a region defined by the plurality of discharge spaces; and a phosphor layer arranged on the concavo-convex portions.

The dielectric layer preferably further includes protrusion portions to function as barrier ribs to define the plurality of discharge spaces. The dielectric layer preferably further includes a porous dielectric material having a plurality of holes. The dielectric layer alternatively preferably further includes a granular aggregate containing a granular dielectric material.

The plasma display panel preferably further includes a protective layer arranged between the dielectric layer and the phosphor layer to protect the dielectric layer.

The plurality of concavo-convex portions are preferably interconnected in a longitudinal direction of the second electrode. The plurality of concavo-convex portions are alternatively preferably grained in a longitudinal direction of the second electrode.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a plan view of a Plasma Display Panel (PDP) according to a first embodiment of the present invention;

FIG. 2 is an enlarged cross-sectional view of the PDP, taken along line A-A of FIG. 1; and

FIG. 3 is a plan view of a PDP according to a second embodiment of the present invention.

### DETAILED DESCRIPTION OF THE INVENTION

Hereinafter, exemplary embodiments of the present invention are described in detail with reference to the attached drawings. Wherever possible, the same reference numbers will be used throughout the drawings to refer to the same or like parts. The same descriptions will not be repeated.

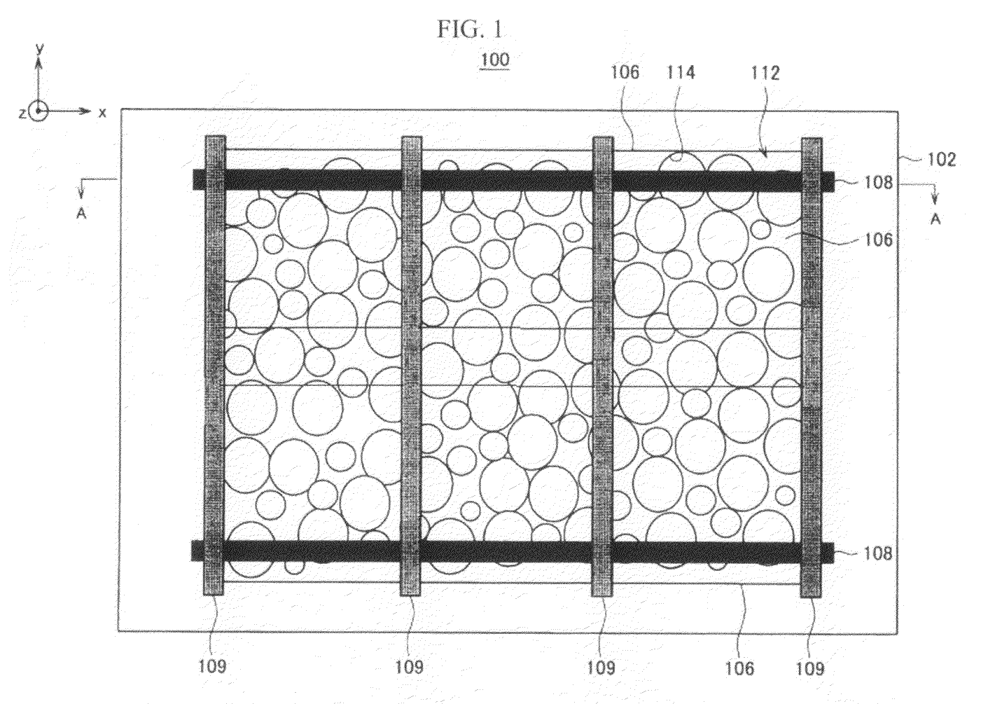

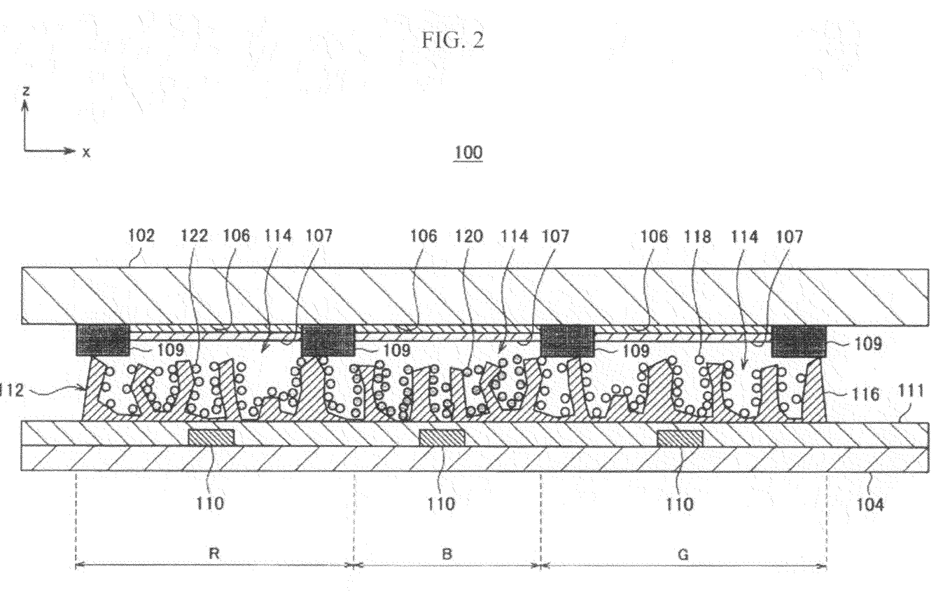

A plasma display panel (PDP) 100 according to a first embodiment of the present invention is described in detail as follows with reference to FIGS. 1 and 2. Referring to FIGS. 1 and 2, the PDP 100 includes a dielectric layer made of a porous dielectric material. Coordinate axes illustrated in FIGS. 1 and 2 will be used in the following descriptions of the PDP 100 of this embodiment. Although the PDP 100 has a two-electrode structure in this embodiment, the present invention is not limited to the PDP 100 having the two-electrode structure. For example, the present invention may also be applied to a PDP having a three-electrode structure.

In this embodiment, the PDP 100 includes a front substrate 102, a rear substrate 104, a plurality of transparent electrodes 106, a plurality of bus electrodes 108, a plurality of rear substrate electrodes 110, and dielectric layers 107, 111, and 112.

The front substrate 102 and the rear substrate 104 are formed as a pair. For example, the front substrate 102 and the rear substrate 104 may be made of soda lime glass. The size of the front substrate 102 and the size of the rear substrate 104 may change depending on a screen size of a plasma display employing the PDP 100 of this embodiment. The PDP 100 can be formed to be thin by reducing the thickness of the front substrate 102 or the thickness of the rear substrate 104. According to the thickness of the plasma display to be manufactured, the thicknesses of these substrates 102 and 104 may be modified.

As shown in FIGS. 1 and 2, the transparent electrodes 106 serving as first electrodes are formed over almost the entire surface of the front substrate 102. The bus electrodes 108 are formed on the front substrate 102 in the x-axis direction. A plurality of black masks 109 are formed on the front substrate 102 in the y-axis direction. The transmissive dielectric layer 107 is formed on the transparent electrodes 106 and the bus electrodes 108. As a result, the transparent electrodes 106 are defined in a plurality of regions by the bus electrodes 108 and the black masks 109. In addition, as shown in FIG. 2, the rear substrate electrodes 110 are formed on the rear substrate 104 as second electrodes in the y-axis direction of FIG. 1. The reflective dielectric layer 111 is formed to cover the rear substrate electrodes 110.

The transparent electrodes 106 are used to generate a plasma discharge. The transparent electrodes 106 are formed on the front substrate 102 of Indium-Tin Oxide (ITO) or the like. A sputtering method or a deposition method may be used to form the transparent electrodes 106.

Since an ITO transparent electrode has a higher resistance and lower electrical conductivity than a metal electrode, the bus electrodes 108 are formed as auxiliary electrodes through which current flows. The bus electrodes 108 are made of a metal having low resistance and high electrical conductivity, such as Cu, Al, or Ag. As clearly shown in FIG. 1, the bus electrodes 108 are formed on the front substrate 102 in the x-axis direction with a predetermined distance therebetween. Furthermore, the transparent electrodes 106 are formed on the front substrate 102 to fill a space between the bus electrodes 108. One edge of the transparent electrodes 106 parallel to the x-axis is connected to the bus electrodes 108 disposed in a positive direction of the y-axis. The other edge of the transparent electrodes 106 parallel to the x-axis is not connected to the bus electrodes 108 is disposed in a negative direction of the y-axis. By connecting the transparent electrodes 106 to the bus electrodes 108 in this manner, one bus electrode 108 is connected to the transparent electrodes 106. The bus electrode 108 and the transparent electrodes 106 are formed in a so-called comb shape.

The black masks 109 are formed on the front substrate 102 in the y-axis direction. The black masks 109 serve as buffers that prevent a color-mixture of two different colored light beams in a boundary surface of adjacent pixels. Since the black masks 109 are formed on the front substrate 102 in the y-axis direction with a predetermined distance therebetween, as shown in FIG. 1, the transparent electrodes 106 are formed on the front substrate 102 to fill a space between the black masks 109. The functions of the black masks 109 are described later in more detail. On the other hand, the transparent electrodes 106 and the black masks 109 may be constructed such that the transparent electrodes 106 are formed on the front substrate 102, and the black masks 109 are formed on the transparent electrodes 106 with a predetermined distance therebetween.

After the transparent electrodes 106, the bus electrodes 108, and the black masks 109 are formed on the front substrate 102, the transparent electrodes 106 and the bus electrodes 108 have to be unexposed to discharge spaces. Therefore, the transparent dielectric layer 107 is formed to cover these electrodes 106 and 108. The transparent dielectric layer 107 may cover not only the transparent electrodes 106 and the bus electrodes 108 but also the black masks 109. A sputtering method or a deposition method may be used to form the transparent dielectric layer 107.

After the transparent dielectric layer 107 is formed, a protective layer may be formed on the transparent dielectric layer 107 by using a material having a small work function, such as MgO. The protective layer protects the transparent dielectric layer 107 against sputtering caused by a plasma generated within the discharge spaces.

Similar to the transparent electrodes 106 formed on the front substrate 102, the rear substrate electrodes 110 serving as the second electrodes are used to generate a plasma discharge. The rear substrate electrodes 110 may be made of a metal having good electrical conductivity, such as Ag, Al, Ni, Cu, Mo, or Cr. As clearly shown in FIG. 2, the rear substrate electrodes 110 may be formed on the rear substrate 104 so that the rear substrate electrodes 110 are displaced from the bus electrodes 108 and are parallel to the black masks 109. In addition, as shown in FIG. 2, the rear substrate electrodes 110 are disposed at the center of the two black masks 109 adjacent in the x-axis direction. However, the rear substrate electrodes 110 are not necessarily disposed at the center of the two black masks 109 adjacent in the x-axis direction. Thus, the rear substrate electrodes 110 may be disposed at a position close to any one of the black masks 109.

A reflective dielectric layer 111 is formed on the rear substrate 104 to cover the rear substrate electrodes 110. The reflective dielectric layer 111 reflects emitted light towards the front substrate 102 from a phosphor material stemming from a plasma generated within the discharge spaces. Furthermore, the reflective dielectric layer 111 prevents the rear substrate electrodes 110 from being exposed to the discharge spaces. A sputtering method or a deposition method may be used to form the reflective dielectric layer 111.

After the reflective dielectric layer 111 is formed, a protective layer may be formed on the reflective dielectric layer 111 by using a material having a small work function, such as MgO. The protective layer protects the reflective dielectric layer 111 against sputtering caused by the plasma generated within the discharge spaces.

Referring to FIG. 1, the transparent electrodes 106, the bus electrodes 108, and the black masks 109 are disposed on the front substrate 102. Referring to FIG. 2, the rear substrate electrodes 110 are disposed on the rear substrate 104. In this manner, a unit region includes one transparent electrode 106, one bus electrode 108, two black masks 109, and one rear substrate electrode 110. This unit region functions as a unit pixel.

In the PDP 100 of this embodiment, the dielectric layer 112 is made of a porous dielectric material. The dielectric layer 112 functions as both barrier ribs and discharge spaces in a conventional PDP. As shown in FIG. 2, the dielectric layer 112 is formed between the front substrate 102 and the rear substrate 104 that face each other with a distance therebetween. The dielectric layer 112 may be made of a dielectric material, such as porous glass. Alternatively, the dielectric layer 112 may be made of a resin blowing agent (e.g., ethyl cellulose), an inorganic blowing agent (e.g., CaCO₃), or a dielectric powder. In the process of forming the dielectric layer 112, the dielectric layer 112 may be formed on the reflective dielectric layer 111 formed on the rear substrate 104, and the front substrate 102 may be disposed above the dielectric layer 112. Alternatively, the dielectric layer 112 may be first formed on the transmissive dielectric layer 107 formed on the front substrate 102, and the rear substrate 104 may be disposed above the dielectric layer 112.

As shown in FIGS. 1 and 2, a plurality of slim holes 114 having various diameters are formed over the entire surface of the porous dielectric layer. Referring to FIG. 1, for convenience, the porous dielectric material has the substantially circular slim holes 114. The diameters of the slim holes 114 are exaggerated in FIG. 1. However, in practice, the slim holes 114 are not limited to the circular shape, and thus the slim holes 114 may have an irregular shape such as a substantially elliptical, rectangular, or polygonal shape. The actual sizes ofthe slim holes 114 are extremely small.

As clearly shown in FIG. 2, the dielectric layer 112 includes the slim holes 114 having various shapes. The slim holes 114 may have various depths. For example, one slim hole 114 may be constructed with a through-hole passing through the dielectric layer 112. Another slim hole 114 may not be constructed with the through-hole. Each slim hole 14 may have a diameter in the range of 10 to 100 μm, preferably 20 to 60 μm. When the diameter of each slim hole 14 is in the range of 20 to 60 μm, a plasma can be further effectively generated. Two adjacent slim holes 114 may be spaced apart from each other by a predetermined distance. Alternatively, the two adjacent slim holes 114 may be irregularly formed to be spaced apart from each other by a distance of about 5 to 20 μm. By reducing the distance between the two adjacent slim holes 114, a hole aperture may be increased, and a coating area of a phosphor material may be increased. As a result, the brightness of the PDP 100 may be improved.

The slim holes 114 are defined by walls 116 of the slim holes 114 each having a predetermined height, for example of about 50 μm. Each wall 116 may have an irregular shape as shown in FIG. 2. The wall 116 may have a specific shape, such as a rectangle.

The porous dielectric layer 112 of this embodiment may be formed by using an inorganic blowing agent resin (e.g., ethyl cellulose) or an inorganic blowing agent (i.e., CaCO₃). That is, a dielectric powder combined with the blowing agent is dispersed in a specific insoluble solvent and is then applied over a substrate. Thereafter, when the temperature is increased to the extent that the blowing agent is dissolved and the dielectric material is softened, the blowing agent is dissolved by heat before the dielectric material is melted. Then, the blowing agent becomes a gas state, thereby being exhausted to the air. In this case, the dielectric powder applied over the surface of the blowing agent maintains its shape. Then, the dielectric powder is sintered immediately. As a result, a gas vent hole maintains its shape without alteration, thereby becoming each slim hole 114.

The porous dielectric layer 112 of this embodiment may be formed by using a method of manufacturing porous glass through a sol-gel process. That is, a silicon organic-inorganic hybrid alkoxide solution may be applied over the substrate and is then hydrolyzed so as to form the slim holes 114 illustrated in FIG. 2. Alternatively, another method may be used in which a phase-separation effect of glass is used to separate glass into two phases with different chemical properties, so that one phase thereof is removed by means of a solvent or the like.

In the PDP 100 of this embodiment, the walls 116 having the aforementioned characteristics function as the barrier ribs defining the discharge spaces. Furthermore, the slim holes 114 of the porous dielectric material function as the discharge spaces.

At least one of a green light emitting phosphor material 118, a blue light emitting phosphor material 120, and a red light emitting phosphor material 122 is selected as a phosphor layer to be formed on the surfaces of the slim holes 114. For example, in order to form a green light emitting region G, the phosphor layer is formed by using the green light emitting phosphor material 118 formed on the transparent electrodes 106, the bus electrodes 108, and the porous dielectric layer 112 formed between the rear substrate electrodes 110. The green light emitting phosphor material 118 is attached to the surfaces of the slim holes 114 existing in the green light emitting region G. The slim holes 114 having the green light emitting phosphor material 118 become discharge spaces for emitting green light.

The slim holes 114 exist in the porous dielectric layer 112 formed between one transparent electrode 106, one bus electrode 108, and one rear substrate electrode 110. Thus the phosphor layer occupies a significantly large surface area in comparison with the conventional PDP in which only one discharge space exists for a pair of front and rear substrate electrodes. Accordingly, in the PDP 100 of this embodiment, the surface area occupied by the phosphor material increases, thereby enhancing its brightness.

Likewise, a blue light emitting region B and a red light emitting region R may be formed in the same manner as the green light emitting region G by using the blue light emitting phosphor material 120 and the red light emitting phosphor material 122.

When the red light emitting region R, the blue light emitting region G, and the blue light emitting region B are formed as described above, any one of the slim holes 114 may have two types of phosphor materials, such as the blue light emitting phosphor material 120 and the red light emitting phosphor material 122. In the slim holes 114, a color-mixture may occur in blue light emission and red light emission if a voltage is supplied between the transparent electrodes 106 and the rear substrate electrodes 110. Such a color-mixture is regarded as being generated at a boundary surface of two adjacent light emitting regions. Thus, the black masks 109 are formed on the boundary surface of the light emitting regions, so that the emitted light is not transmitted to the outside of the PDP 100.

A space within each slim hole 114 need not be a vacuum. A Ne—Xe gas containing Xe as a main discharge gas may be contained within the space. A certain amount of discharge gas of Ne may be optionally replaced by 0=9 He.

A protective layer may be formed on the surfaces of the walls 116 of the slim holes 114 and between the phosphor materials 118, 120, and 122 by further forming a film made of a material having a small work function, such as MgO. By forming the protective layer, the surface of the porous dielectric material is coated. In addition, even if a plasma discharge occurs between the transparent electrodes 106, the bus electrodes 108, and the rear substrate electrodes 110, the porous dielectric material is prevented from being etched by the plasma.

The slim holes 114 may be spatially interconnected in a longitudinal direction (y-axis direction) of the rear substrate electrodes 110. A space for interconnecting the slim holes 114 facilitates diffusion of discharge between the transparent electrodes 106. The porous dielectric layer 112 is grained by the slim holes 114 and the walls 116, thereby improving a discharge diffusion capability.

The operation of the PDP 100 of this embodiment is as follows. When an AC voltage greater than a discharge ignition voltage is supplied between the transparent electrodes 106, the bus electrodes 108, and the rear substrate electrodes 110, a discharge path is formed between the respective electrodes whenever the polarity of the voltage supplied to the electrodes changes. Furthermore, a plasma discharge occurs from a discharge gas existing in the discharge path. As a result, ultraviolet rays are emitted to a discharge space. The ultraviolet rays emitted to the discharge space collide against a phosphor material disposed in the discharge space. The phosphor material emits light by using energy contained in the ultraviolet rays. The emitted light of the phosphor material is transmitted through the transparent electrodes 106 and the front substrate 102 and proceeds to the outside of the PDP 100. In addition, the emitted light of the phosphor material proceeding towards the rear substrate 104 is reflected by the reflective dielectric layer 111 and thus proceeds towards the front substrate 102.

In the PDP 100 of this embodiment, a plurality of discharge spaces are present between one transparent electrode 106 and one rear substrate electrode 110 that are formed in pairs. A coating area of a phosphor layer formed in the discharge spaces is significantly larger than that of the conventional PDP by utilizing the slim holes 114 of the porous dielectric layer. Therefore, the PDP 100 of this embodiment can have improved brightness and efficiency in comparison with the conventional PDP.

A plasma display employing the PDP 100 of this embodiment may be manufactured by connecting the PDP 100 with a driver circuit or other devices, wherein the drive circuit is provided to control the transparent electrodes 106, the bus electrodes 108, and the rear substrate electrodes 110. The plasma display employing the PDP 100 may be manufactured by using all possible well-known methods.

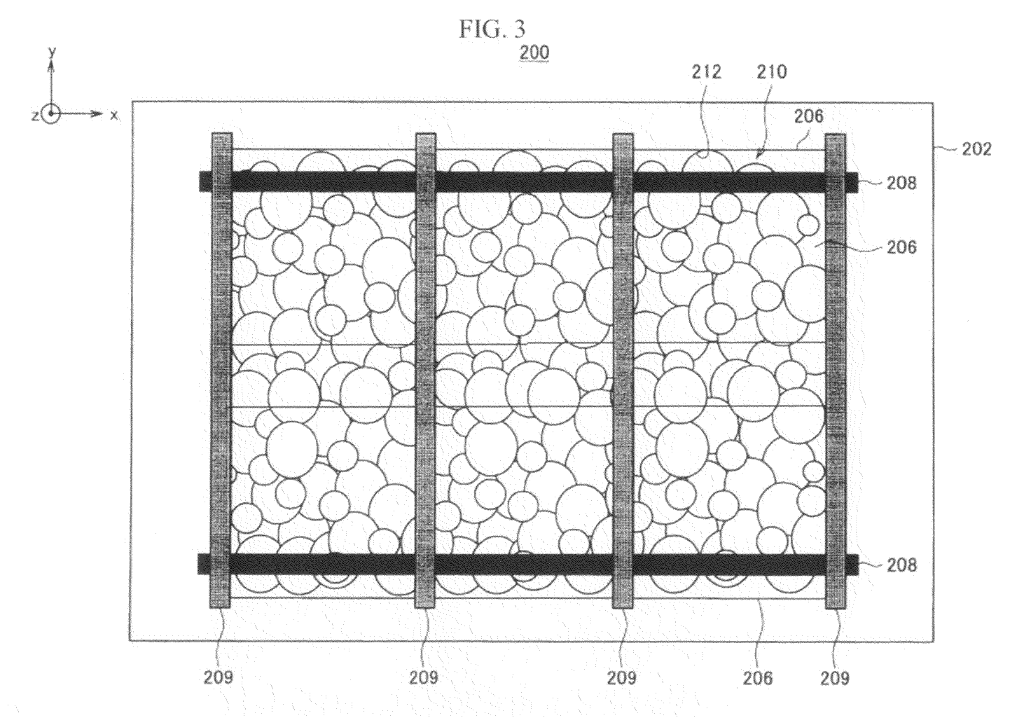

A PDP 200 according to a second embodiment of the present invention is described in detail as follows with reference to FIG. 3. A porous dielectric material is used in the PDP 100 of the first embodiment as a dielectric layer. However, in the PDP 200 of FIG. 3, the dielectric layer is formed of an aggregate of granular dielectric materials. Although the PDP 200 has a two-electrode structure in the second embodiment, the present invention is not limited to the PDP 200 having the two-electrode structure. That is, the present invention may be also applied to a PDP having a three-electrode structure.

FIG.3 is a plan view of the PDP 200 according to the second embodiment of the present invention. Referring to FIG. 3, the PDP 200 of this embodiment may include a front substrate 202, a plurality of transparent electrodes 206, a plurality of bus electrodes 208, and a dielectric layer 210 containing granular dielectric materials 212. In addition, the PDP 200 may further include: a transmissive dielectric layer that covers the transparent electrodes 206 and the bus electrodes 208; a rear substrate facing the front substrate 202; a plurality of rear substrate electrodes disposed on the rear substrate; and a reflective dielectric layer formed on the rear substrate to cover the rear substrate electrodes.

The front substrate 202 and the rear substrate (not shown) are formed of a specific size, and as an example, the front substrate 202 and the rear substrate may be made of soda lime glass. The size of the front substrate 202 and the size of the rear substrate may change depending on a screen size of a plasma display employing the PDP 200 of this embodiment. The PDP 200 can be formed to be thin by reducing the thickness of the front substrate 202 or the thickness of the rear substrate. According to the thickness of the plasma display to be manufactured, the thicknesses of these substrates may be modified.

As shown in FIG. 3, the transparent electrodes 206 serving as first electrodes are formed over almost the entire surface of the front substrate 202. The bus electrodes 208 are formed on the front substrate 202 in the x-axis direction. A plurality of black masks 209 are formed on the front substrate 202 in the y-axis direction. The transmissive dielectric layer (not shown) is formed on the transparent electrodes 206 and the bus electrodes 208. As a result, the transparent electrodes 206 are defined by the bus electrodes 208 and the black masks 209 in a plurality of regions. In addition, similar to the PDP 100 of the first embodiment, the rear substrate electrodes (not shown) are formed on the rear substrate (not shown) as second electrodes in the y-axis direction. The reflective dielectric layer (not shown) is formed to cover the rear substrate electrodes.

The transparent electrodes 206 serving as the first electrodes are used to generate a plasma discharge. The transparent electrodes 206 are formed on the front substrate 202 of ITO or the like. A sputtering method or a deposition method may be used to form the transparent electrodes 206.

An ITO transparent electrode has a higher resistance and lower electrical conductivity than a metal electrode. Thus, the bus electrodes 208 are formed as auxiliary electrodes through which current flows. The bus electrodes 208 are made of a metal having low resistance and high electrical conductivity, such as Cu, Al, or Ag. As clearly shown in FIG. 3, the bus electrodes 208 are formed on the front substrate 202 in the x-axis direction with a predetermined distance therebetween. Furthermore, the transparent electrodes 206 are formed on the front substrate 202 and are disposed between the bus electrodes 208. One edge of the transparent electrodes 206 parallel to the x-axis is connected to the bus electrodes 208 disposed in a positive direction of the y-axis. The other edge of the transparent electrodes 206 parallel to the x-axis is not connected to the bus electrodes 208 disposed in a negative direction of the y-axis. By connecting the transparent electrodes 206 and the bus electrodes 208 in this manner, one bus electrode 208 is connected to the transparent electrodes 206. The bus electrode 208 and the transparent electrodes 206 are formed in a so-called comb shape.

After the transparent electrodes 206, the bus electrodes 208, and the black masks 209 are formed on the front substrate 202, the transparent electrodes 206 and the bus electrodes 208 have to be unexposed to discharge spaces. Therefore, the transparent dielectric layer (not shown) is formed to cover these electrodes 206 and 208. The transparent dielectric layer may cover not only the transparent electrodes 206 and the bus electrodes 208 but also the black masks 209. A sputtering method or a deposition method may be used to form the transparent dielectric layer.

After the transparent dielectric layer is formed, a protective layer may be formed on the transparent dielectric layer by using a material having a small work function, such as MgO.

The black masks 209 are formed on the front substrate 202 in the y-axis direction. The black masks 209 serve as buffers that prevent color-mixture of two different colored light beams in a boundary surface of adjacent pixels. Since the black masks 209 are formed on the front substrate 202 in the y-axis direction with a predetermined distance therebetween as shown in FIG. 3, the transparent electrodes 206 are disposed to fill a space between the black masks 209 when formed on the front substrate 202.

The rear substrate (not shown) and the reflective dielectric layer (not shown) have the same functions and advantages as the rear substrate electrodes 110 and the reflective dielectric layer 111 of the PDP 100 of the first embodiment. Therefore, descriptions thereof have been omitted.

The dielectric layer 210 is disposed between the front substrate 202, on which the transparent electrodes 206 and the bus electrodes 208 are formed, and the rear substrate (not shown) on which the rear substrate electrodes are formed. As shown in FIG. 3, the dielectric layer 210 is composed of an aggregate of granular dielectric materials 212. Referring to FIG. 3, for convenience, the dielectric materials 212 have a substantially spherical shape. The diameters of the dielectric materials 212 are exaggerated in the figure. However, in practice, the dielectric materials 212 are not limited to the spherical shape, and thus the dielectric materials 212 may have a unique shape. The actual sizes of the dielectric materials 212 are extremely small.

As shown in FIG. 3, the dielectric materials 212 are generally formed in various shapes and sizes. Thus, when these dielectric materials 212 form an aggregate, a space is not filled with the densely formed dielectric materials 212. Instead, a plurality of spaces having various shapes and sizes are defined between the adjacent dielectric materials 212. The shapes and sizes of the defined spaces are not predetermined. Thus, the spaces have irregular shapes and sizes. The height of the aggregate that is formed with the adjacent dielectric materials 212 varies depending on the extent of overlapping of the dielectric materials 121. Concavo-convex portions are formed on the surface of the dielectric layer 210. In the process of forming the dielectric layer 210, the dielectric layer 210 may be formed on the rear substrate (not shown), and the front substrate 202 may be disposed above the dielectric layer 210. Alternatively, the dielectric layer 210 may be first formed on the front substrate 202, and the rear substrate may be disposed above the dielectric layer 210.

In the PDP 200 of this embodiment, a space not containing the dielectric materials 212 formed on the dielectric layer 210 and a concave portion that is formed by the aggregate of the dielectric materials 212 are used as discharge spaces. Furthermore, protrusion portions formed by the aggregate of the dielectric materials 212 are used as barrier ribs.

The aggregate of the dielectric materials 212 may be formed by using various methods such as sputtering, deposition, and physical and chemical absorptions. The shape and size of the concave portion or the shape and size of the space not containing the dielectric materials 212 may be regulated by changing a condition of forming the aggregate.

A protective layer may be formed on the surfaces of the dielectric materials 212 by further forming a film made of a material having a small work function, such as MgO. By forming the protective layer, the surfaces of the dielectric materials 212 are coated. In addition, even if a plasma discharge occurs between the transparent electrodes 206, the bus electrodes 208, and the rear substrate electrodes (not shown), the dielectric materials 212 are prevented from being etched by the plasma.

A phosphor layer is formed by applying a phosphor material (not shown) in the concave portion and the space not containing the dielectric materials 212. The phosphor layer receives ultraviolet rays generated by a plasma discharge so as to emit a visible light beam in a specific wavelength range. The wavelength of the emitted visible light beam may change by modifying a phosphor material contained in the phosphor layer. The PDP 200 of this embodiment requires three regions for emitting red (R) light, green (G) light, and blue (B) light. Thus, at least three types of phosphor materials are required. In this case, the concavo-convex portions each having a size similar to the granule size of the dielectric materials 212 are present in the dielectric layer 210 of this embodiment. Therefore, the surface area of the phosphor layer is significantly larger than that of the conventional PDP. Regions for emitting respective colors, that is, a unit pixel, can be formed by respectively modifying the regions having a red light emitting phosphor material, a blue light emitting phosphor material, and a green light emitting phosphor material.

When a red light emitting region R, a green light emitting region G, and a blue light emitting region B are formed as described above, two types of phosphor materials may be attached to any one of the concavo-convex portions thereof. A color mixture caused by each phosphor material may occur in the concavo-convex portions in the case where a voltage is supplied between the transparent electrodes 206 and the rear substrate electrodes. Such a color-mixture is regarded as being generated at a boundary surface of two adjacent emission regions. Thus, the black masks 209 are formed on the boundary surface of the emission regions, so that the emitted light is not transmitted to the outside of the PDP 200.

A Ne—Xe gas containing Xe as a main discharge gas may be contained within the concave portions of the dielectric layer 210 or in an air gap, such as the space not containing the dielectric material 212. A certain amount of discharge gas of Ne may be optionally replaced by He.

Although not shown, the concave portion of the dielectric layer 210 and the dielectric materials 212 may be spatially interconnected in a longitudinal direction (y-axis direction) of the rear substrate electrodes (indicated by 110 in FIG. 2). A space for interconnecting the concave portions facilitates diffusion of a discharge between the transparent electrodes 206. The dielectric layer 210 is grained by the concave portions and the dielectric materials 212, thereby improving a discharge diffusion capability.

The operation of the PDP 200 of this embodiment is as follows. When an AC voltage greater than a discharge ignition voltage is supplied between the transparent electrodes 206, the bus electrodes 208, and the rear substrate electrodes, a discharge path is formed between the respective electrodes whenever the polarity of the voltage supplied to the electrodes changes. Furthermore, a plasma discharge occurs from a discharge gas existing in the discharge path. As a result, ultraviolet rays are emitted towards a discharge space. The ultraviolet rays emitted towards the discharge space collide against a phosphor material disposed in the discharge space. The phosphor material emits light by using energy contained in the ultraviolet rays. The emitted light of the phosphor material is transmitted through the transparent electrodes 206 and the front substrate 202 and proceeds to the outside of the PDP 200. In addition, the emitted light of the phosphor material proceeding towards the rear substrate is reflected from the reflective dielectric layer and thus proceeds towards the front substrate 202.

In the PDP 200 of this embodiment, a plurality of discharge spaces are present between one transparent electrode 206 and one rear substrate electrode which are formed as a pair. A coating area of a phosphor layer formed in the discharge spaces is significantly large than that of the conventional PDP by utilizing the concavo-convex portions of the dielectric layer 210. Therefore, the PDP 200 of this embodiment can have improved brightness and efficiency in comparison with the conventional PDP.

A plasma display employing the PDP 200 of this embodiment may be manufactured by connecting the PDP 200 to a driver circuit or other devices, wherein the drive circuit is provided to control the transparent electrodes 206, the bus electrodes 208, and the rear substrate electrodes. The plasma display employing the PDP 200 may be manufactured by using all possible well-known methods.

Hereinafter, exemplary embodiments of a PDP of the present invention are described as follows. In the following embodiments, a two-electrode type of AC-PDP will be exemplified in which electrodes are respectively formed on a front substrate and a rear substrate.

First, an address electrode is formed on the rear substrate by using a rear substrate electrode. The address electrode is formed by patterning a photo-sensitive silver (Ag) paste. Thereafter, a reflective dielectric layer is formed to cover the address electrode.

Subsequently, a dielectric layer is formed. Dielectric powder having a diameter less than 2 μm is attached to the surface of a resin ball composed of ethyl cellulose having a diameter of about 10 μm by using a mechano-chemical method.

The resin ball with the attached dielectric powder is dispersed in water that does not melt the resin ball. Then, the resin ball is dried after being uniformly applied over the rear substrate. The applying/drying process is repeated several times so as to form a dielectric layer with a thickness of about 50 μm.

Thereafter, the rear substrate on which the dielectric layer is formed is heated until the temperature reaches above a softening point of the dielectric material. By doing so, the resin ball composed of ethyl cellulose is dissolved by heat before the dielectric powder is melted. Then, the resin ball becomes a gas state, thereby being exhausted to the air. In this case, the dielectric powder applied over the surface of the resin ball maintains its shape. Then, the dielectric powder is sintered immediately.

Since a vaporized gas of ethyl cellulose is exhausted from the upper surface of the dielectric layer, a porous sintered material is formed in which openings of slim holes are formed on the surface of the dielectric layer. Thereafter, the surface of the dielectric layer is uniformly polished. Phosphor material granules of a desired size are attached to the slim holes and various methods may be used to attach the phosphor material. In this embodiment, a dispenser method is used. Specifically, red light emitting phosphor ink droplets having a size of less than 1 μm that are dispersed into alcohol are applied to a desired region by using a dispenser device. Then, the applied ink droplets are dried. The same process is performed with respect to blue light emitting phosphor ink droplets and green light emitting phosphor ink droplets.

Subsequently, the front substrate is formed. A transparent electrode and a bus electrode are patterned on the front substrate in a desired shape. The surface thereof is covered with a transparent dielectric material.

Thereafter, the front substrate and the rear substrate are bonded to each other so that electrodes are aligned to regions where the phosphor materials are applied. A discharge gas is filled therein, thereby completing a PDP.

A PDP of another embodiment is manufactured in the same manner as the first embodiment except that a dielectric layer is formed by using a method described below.

The dielectric layer is formed by using a silicon organic-inorganic hybrid alkoxide. This material is an alcohol solution, such as tetra-alkoxy silane or tri-alkoxy alkylsiloxane. The solution is applied over the rear substrate. A temperature of below 100° C. is maintained for several hours so as to produce a spinodal powder. As a result, porous glass is formed of which the principal component is SiO₂ and that has slim holes of about 15 to 20 μm.

Although relative discharge type PDPs in which a plasma discharge occurs in a substantially vertical direction have been described in the aforementioned embodiments, the present invention may also be applied to a surface charge type of PDP.

According to the present invention, a coating area of a phosphor material in a discharge space can be increased. Furthermore, brightness and efficiency of the PDP can be improved.

While the present invention has been particularly shown and described with reference to exemplary embodiments thereof, it will be understood by those skilled in the art that various modifications in form and detail may be made therein without departing from the spirit and scope of the present invention as defined by the appended claims.

What is claimed is:

1. A plasma display panel comprising:
a front substrate to transmit light therethrough;
a rear substrate facing the front substrate;
a plurality of discharge spaces arranged between the front substrate and the rear substrate;
a first electrode arranged on the front substrate;
a second electrode arranged on the rear substrate to cross the first electrode to generate a discharge within one of the plurality of discharge spaces between the first electrode and the second electrode;
a dielectric layer arranged on the rear substrate facing the plurality of discharge spaces and having a plurality of concavo-convex portions in a region defined by the plurality of discharge spaces; and
a phosphor layer arranged on the concavo-convex portions.

2. The plasma display panel of claim 1, wherein the dielectric layer further comprises protrusion portions to function as barrier ribs to define the plurality of discharge spaces.

3. The plasma display panel of claim 1, wherein the dielectric layer further comprises a porous dielectric material having a plurality of holes.

4. The plasma display panel of claim 1, wherein the dielectric layer further comprises a granular aggregate containing a granular dielectric material.

5. The plasma display panel of claim 1, further comprising a protective layer arranged between the dielectric layer and the phosphor layer to protect the dielectric layer.

6. The plasma display panel of claim 3, further comprising a protective layer arranged between the dielectric layer and the phosphor layer to protect the dielectric layer.

7. The plasma display panel of claim 4, further comprising a protective layer arranged between the dielectric layer and the phosphor layer to protect the dielectric layer.

8. The plasma display panel of claim 1, wherein the plurality of concavo-convex portions are interconnected in a longitudinal direction of the second electrode.

9. The plasma display panel of claim 1, wherein the plurality of concavo-convex portions are grained in a longitudinal direction of the second electrode.
